(19) United States
(12) Patent Application Publication
(10) Pub. No.: US 2020/0073636 A1
(43) Pub. Date: Mar. 5, 2020

(54) MULTIPLY-ACCUMULATE (MAC) OPERATIONS FOR CONVOLUTIONAL NEURAL NETWORKS

(71) Applicant: QUALCOMM Incorporated, San Diego, CA (US)

(72) Inventors: Rosario CAMMAROTA, San Diego, CA (US); Manu RASTOGI, San Diego, CA (US)

(21) Appl. No.: 16/120,001

(22) Filed: Aug. 31, 2018

(51) Int. Cl. G06F 7/523; G06N 3/04; G06N 3/08

(52) U.S. Cl. CPC G06F 7/523; G06N 3/0445; G06N 3/08; G06N 3/04

(57) ABSTRACT

An integrated circuit is configured to compute multiply-accumulate (MAC) operations in convolutional neural networks. The integrated circuit includes a lookup table (LUT) configured to store multiple values. The integrated circuit also includes a compute unit. The compute unit is composed of an accumulator. The compute unit also includes a first multiplier configured to receive a first value of a padded input feature and a first weight of a filter kernel. The compute unit also includes a first selector. The first selector is configured to select an input to supply to the accumulator between an output from the first multiplier and an output from the LUT.

### BACKGROUND

### Field

Certain aspects of the present disclosure generally relate to convolutional neural networks and, more particularly, to fast multiply-accumulate (MAC) operations for convolutional neural networks (CNNs).

### Background

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

In layered neural network architectures, the output of a first layer of neurons becomes an input to a second layer of neurons, the output of a second layer of neurons becomes an input to a third layer of neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

Convolutional neural networks, however, tend to shrink input features during computations through the various network layers. Shrinking of the input feature size during computations fails to preserve an original size of the input features. Input feature padding may be used to preserve the input feature size during computations through the neural network layers. Although input feature padding preserves the input feature size, processing of the padded values increases computational complexity in convolutional neural networks.

### SUMMARY

An integrated circuit is configured to compute multiply-accumulate (MAC) operations in convolutional neural networks. The integrated circuit includes a lookup table (LUT) configured to store multiple values. The integrated circuit also includes a compute unit. The compute unit is composed of an accumulator. The compute unit also includes a first multiplier configured to receive a first value of a padded input feature and a first weight of a filter kernel. The compute unit also includes a first selector. The first selector is configured to select an input to supply to the accumulator between an output from the first multiplier and an output from the LUT.

A method performs multiply-accumulate (MAC) operations in convolutional neural networks. The method includes searching for a stored multiplication result in a lookup table (LUT) corresponding to a multiplication product of an input feature value of a padded input feature and a filter weight of a kernel filter. The method also includes disabling a multiplier during a multiplication operation of the multiplication product when a lookup table hit of the multiplication product is detected. The method further includes storing a computed multiplication product of the input feature value and the filter weight when a lookup table miss of the multiplication product is detected.

An integrated circuit is configured to perform multiply-accumulate (MAC) operations in convolutional neural networks. The integrated circuit includes means for searching for a stored multiplication result in a lookup table (LUT) corresponding to a multiplication product of a first value of a padded input feature value and a first weight of a filter kernel. The integrated circuit also includes means for disabling a multiplier during a multiplication operation of the multiplication product when a lookup table hit of the multiplication product is detected. The integrated circuit further includes means for storing a computed multiplication product of the first value of the padded input feature and the first weight of the filter kernel when a lookup table miss of the multiplication product is detected.

This has broadly outlined the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5A is a block diagram illustrating fast multiply-accumulate (MAC) operations leveraging padding types and their properties in convolutional networks (CNNs), according to aspects of the present disclosure.

FIG. 5B is a block diagram illustrating multilayer padding of an input feature to maintain input feature size during a multiply-accumulate (MAC) operation using a filter, according to aspects of the present disclosure.

FIG. 6 is a block diagram of an integrated circuit device illustrating a compute unit including a multiply-accumulate (MAC) cell configured to perform fast MAC operations by leveraging padding types and their properties in convolutional networks (CNNs), according to aspects of the present disclosure.

FIG. 7 is a block diagram of an integrated circuit device further illustrating a compute unit including the multiply-accumulate (MAC) cell of FIG. 6, configured to perform fast MAC operations in a zero padding configuration, in accordance with aspects of the present disclosure.

FIG. 8 is a block diagram of an integrated circuit device further illustrating a compute unit including the multiply-accumulate (MAC) cell of FIG. 6 configured to perform fast MAC operations in a constant padding configuration, according to aspects of the present disclosure.

FIG. 9 is a block diagram of an integrated circuit device further illustrating a compute unit including the multiply-accumulate (MAC) cell of FIG. 6 configured to perform fast MAC operations in a mirror padding configuration, according to aspects of the present disclosure.

FIG. 10 is a block diagram of an integrated circuit device illustrating a compute unit including the multiply-accumulate (MAC) cell of FIG. 6 configured to perform fast MAC operations during a lookup table hit, according to aspects of the present disclosure.

FIG. 11 illustrates a method for fast multiply-accumulate (MAC) operations in a convolutional neural network (CNN) according to a padding type, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In convolutional neural networks, padding is a layer pre-processing technique for which padding values are known. Hence, a portion of the computationally intensive MAC operations (e.g., the multiplications) can use the known information about the padding values to speed up multiplications, and overall MAC operations—by a single MAC operation or multiple simultaneous MAC operations. For example, in applications that involve a hardware accelerator, information about known values can be exploited to speed up operations by specializing the circuitry.

Aspects of the present disclosure are directed to improving the multiplication portion of MAC operations in convolutional neural networks by leveraging the padded values. Once pre-processing/padding of the neural network activations is complete, the values written in the padding area are known. Aspects of the present disclosure leverage this knowledge by augmenting the traditional multiply and add schema by using a lookup table and an address generator. In one configuration, items in the lookup table are addressed as a function of the current multiplier, an activation value, and a weight value, while new multiplication products are stored in the lookup table to enable subsequent fast MAC operations in a convolutional network.

The activations computed in a previous network layer are read from memory and processed at the next layer of a neural network by multiplying activation values by corresponding weights and accumulating a sum. This multiplication and accumulation operation may be a hardware computation of a dot product of a corresponding weight to an activation value for each clock cycle. In operation, this process may be improved by performing address generation and table look up in parallel to the actual multiply-accumulate operation. The lookup can be a hit or a miss. If a miss occurs, this indicates the value was not previously computed. In this case, the value is computed and stored in the lookup table at the generated address for later use. When a hit is detected, this indicates the value was previously computed. When a hit occurs, the lookup table is accessed to return the value of the multiplication, and the actual multiplication is aborted.

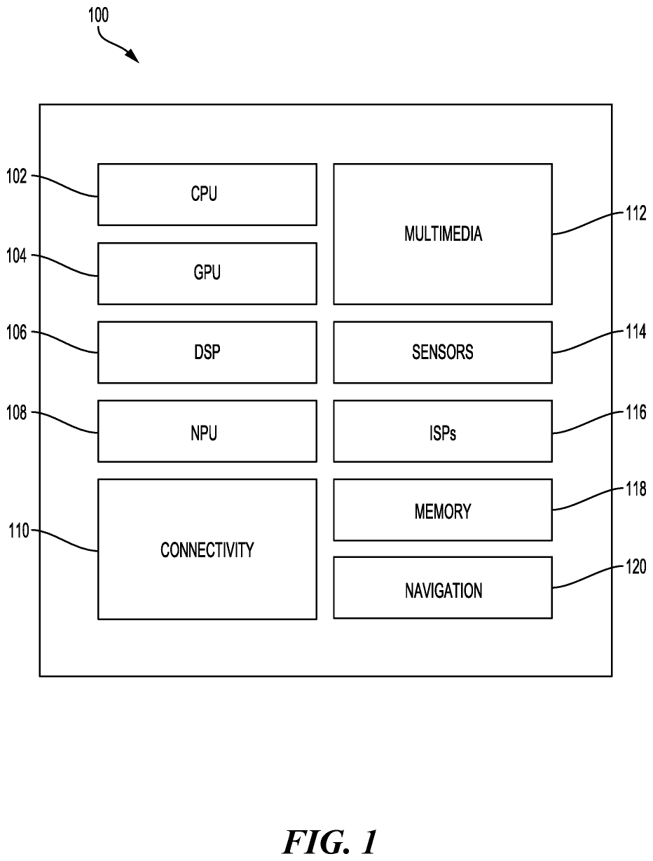

FIG. 1 illustrates an example implementation of a system-on-a-chip (SOC) 100, which may include a central processing unit (CPU) 102 or a multi-core CPU configured to perform fast multiply-accumulate (MAC) operations in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input feature value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input feature and the filter weight when a lookup table miss of the multiplication product is detected.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

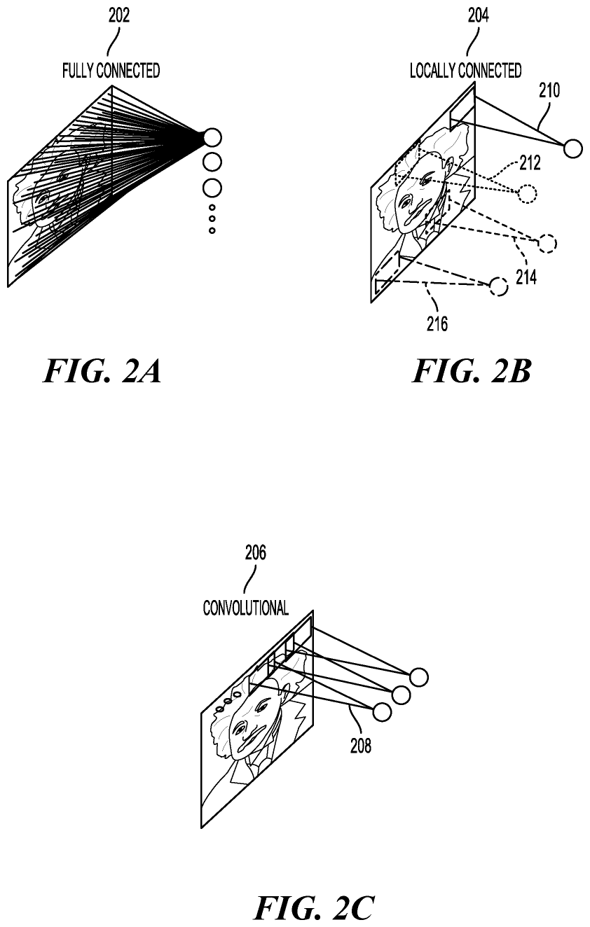

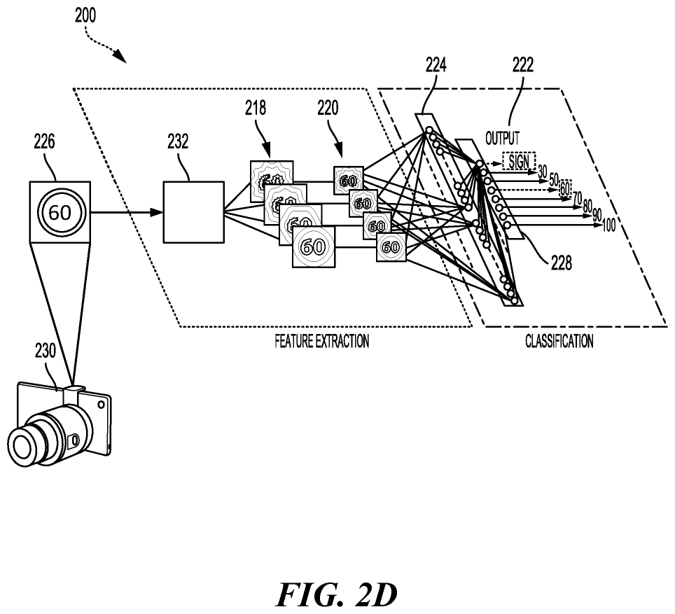

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

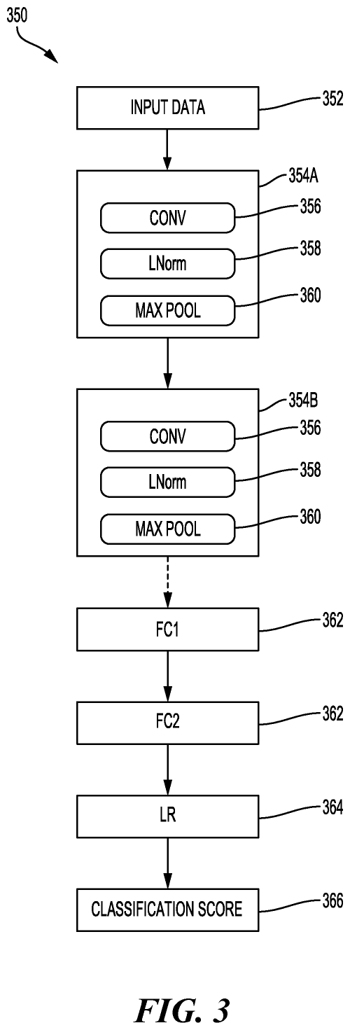

FIG. 3 is a block diagram illustrating a deep convolutional network 350. The deep convolutional network 350 may include multiple different types of layers based on connectivity and weight sharing. As shown in FIG. 3E, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

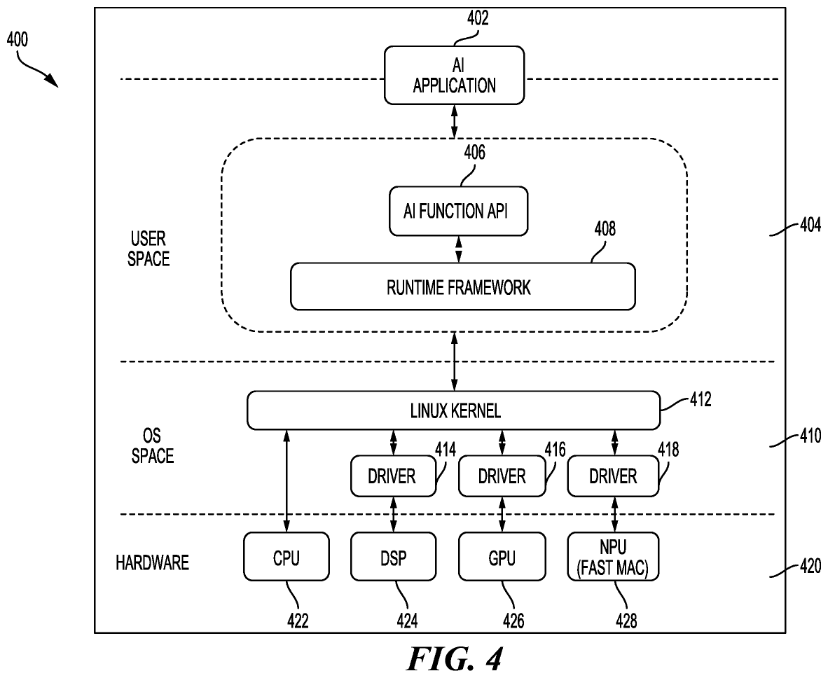

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support fast multiply-accumulate (MAC) computations during run-time operation of an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Linux Kernel 412, running on the SOC 420. The operating system, in turn, may cause a fast MAC computation to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

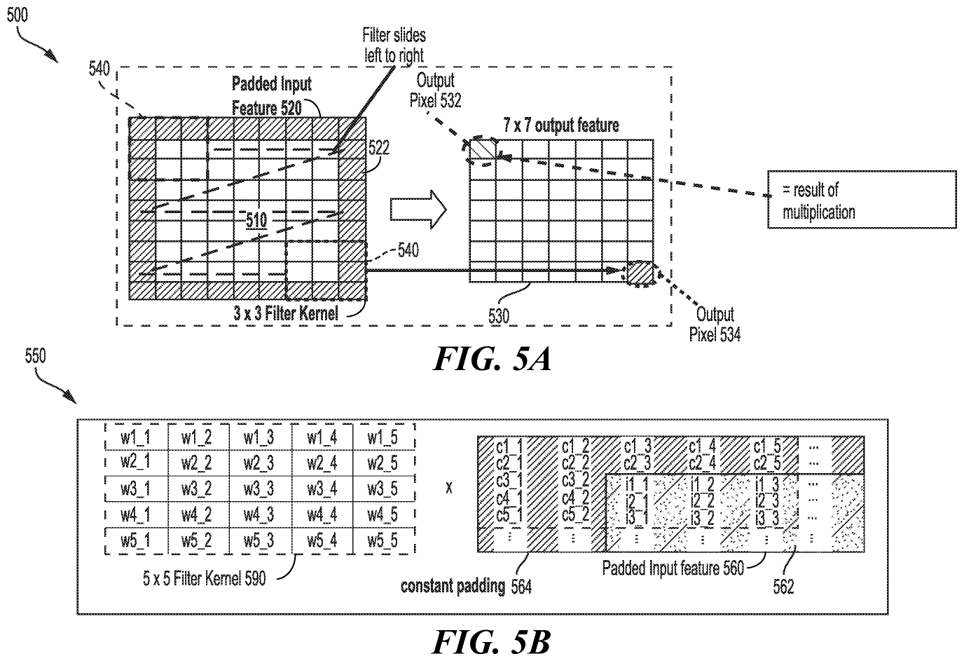

FIG. 5A is a block diagram 500 illustrating fast multiply-accumulate (MAC) operations by leveraging padding types and their properties in convolutional networks (CNNs), according to aspects of the present disclosure. Representatively, a padded input feature 520 is shown. In this example, a 7×7 input feature 510 is padded with a single layer of padding 522 to form the padded input feature 520. The padding 522 added to the 7×7 input feature 510 is used to maintain the original size of the 7×7 input feature 510 during processing through a convolutional layer using a 3×3 filter kernel 540 to produce a 7×7 output feature 530.

As shown in FIG. 5A, the padded input feature 520 is processed by applying the 3×3 filter kernel 540 to 3×3 areas of the padded input feature 520. In this example, a first 3×3 area of the padded input feature 520 is multiplied and accumulated with the 3×3 filter kernel 540 to compute a first output pixel 532 of a 7×7 output feature 530 (e.g., matrix multiplication). This process is repeated as the 3×3 filter kernel 540 slides left to right and top to bottom in a zig-zag pattern until a last 3×3 area of the padded input feature 520 is processed to compute a final output pixel of the 7×7 output feature 530. That is, the weights in the 3×3 filter kernel 540 are multiplied by the 3×3 areas in the padded input feature 520. The results from multiplying the 3×3 filter kernel 540 to the 3×3 areas of the padded input feature 520 are output to a new pixel (e.g., 532, 534) of the 7×7 output feature 530. In total, 49 3×3 matrix multiplications are performed to generate output feature 530 from padded input feature 520 and filter kernel 540. It should be recognized that the order/direction of traversal is exemplary, and other orders/directions of traversal are contemplated.

FIG. 5B is a block diagram 550 illustrating multilayer padding of a padded input feature 560 to maintain an input feature size during multiply-accumulate (MAC) operations using a 5×5 filter kernel 590, according to aspects of the present disclosure. In this example, a padded input feature 560 is composed of input feature values 562 (i1_1, i1_2, . . . , i3_3) and the constant padding values 564, which illustrate a multilayer (e.g., =2 layer) constant padding type. The constant padding values 564 may be added at an input of a convolutional neural network or layer by layer in the neural network. Although shown using the constant padding type, it should be recognized that other padding types are considered, including zero padding type, reflective mirror padding type, symmetric mirror padding type, and edge mirror padding type. For example, the mirror padding types may be beneficial in style transfer applications. As shown in FIGS. 5A and 5B, symmetrical padding may involve an odd sized filter kernel, in which the number of padding layers is selected based on the filter kernel size (e.g., padding layer(s)=(filter kernel size−1)/2).

In neural networks, padding is a layer pre-processing technique for which padding values are known. Hence, a portion of the computationally intensive MAC operations (e.g., the multiplications) can use the known information about the padding values to speed up multiplications, and overall MAC operations, by a single MAC operation or multiple simultaneous MAC operations. For example, in applications that involve a hardware accelerator, information about known values can be exploited to speed up operations by specializing the circuitry.

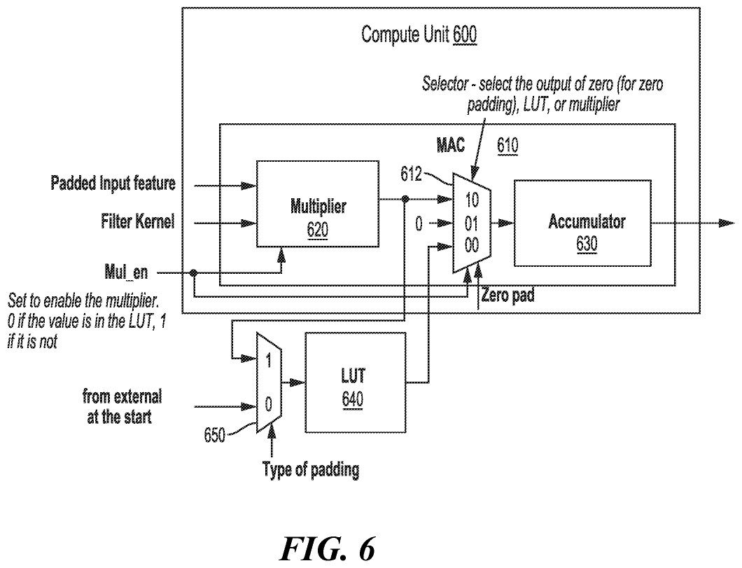

Aspects of the present disclosure are directed to improving the multiplication portion of MAC operations in convolutional neural networks by leveraging the padded values. Once pre-processing/padding of the neural network activations is complete, the values written in the padding area are known. Aspects of the present disclosure leverage this knowledge by augmenting the traditional multiply and add schema by using a lookup table and an address generator. In one configuration, items in the lookup table are addressed as a function of a multiplier, an activation value, and a weight value, for example, as shown in FIG. 6.

FIG. 6 is a block diagram of an integrated circuit device illustrating a compute unit 600 configured to perform fast MAC operations by leveraging padding types and their properties in convolutional neural networks (CNNs), according to aspects of the present disclosure. In this configuration, the compute unit 600 is composed of a first multiply-accumulate (MAC) cell 610, including a multiplier 620 (e.g., a first multiplier), an accumulator 630 (e.g., a first accumulator), and a multiplexer 612 (e.g., a first multiplexer) configured to couple an output of the multiplier 620 to an input of the accumulator 630. The multiplier 620 may be configured to multiply an area of the input feature (e.g., the first 3×3 area of the padded input feature 520) by a filter kernel (e.g., the 3×3 filter kernel 540), for example, as shown in FIG. 5A.

Referring again to FIG. 6, a lookup table (LUT) 640 is shown separate from the compute unit 600. To conserve processing resources, results from previous multiplication operations may be stored in the lookup table 640. For example, items in the lookup table 640 are addressed as a function (e.g., concatenation) of a multiplier, an activation value, and a weight value. In operation, address generation and table look up are performed in parallel to the actual multiply-accumulate operation using the multiplexer 612 (e.g., first selector). The lookup in the lookup table 640 can be a hit or a miss. If a miss occurs, this indicates a new multiplication product value that was not previously computed. In this case, the multiplication product value is computed by the multiplier 620 and stored in the lookup table 640 at the generated address for later use.

In operation, detecting a hit in the lookup table 640 indicates a multiplication value was previously computed. The lookup table 640 is accessed to return the stored multiplication value, and the actual multiplication operation is aborted. In this configuration, the lookup table 640 stores new multiplication product values during a first pass. While fast MAC operation may be diminished during the first pass, the lookup table 640 may be stored with precomputed values corresponding to the padding of an input feature, such as the padded input feature 520 of FIG. 5A. As a result, fast MAC operations are performed when processing padding of an input feature during the first pass and subsequent passes. The lookup table 640 may be limited in size (e.g., up to 256 values).

In aspects of the present disclosure, the first MAC cell 610 performs a fast MAC operation by selectively providing the stored multiplication product value from the lookup table 640 to the accumulator 630 in response to a lookup table hit. In this example, the multiplexer 612 selectively provides a multiplier output, a zero (for zero padding), or the output of the lookup table 640 during a fast MAC operation. Zero padding is enabled by, for example, selecting a zero input to the multiplexer 612 using a zero padding select line (e.g., Zero pad). A multiply enable line (Mul_en) signal disables the multiplier 620 in response to the lookup table hit when a stored multiplication product value is detected in the lookup table 640 and enables the multiplier 620 in response to a lookup table miss.

In this configuration, a multiplexer 650 (e.g., a second selector or off-cell selector) enables storage of multiplication values in the lookup table 640 by supplying an output of the multiplier 620 for storage in the lookup table 640 from a first input. According to aspects of the present disclosure, following pre-processing/padding of the neural network activations, the values that are written in the padding area as well as the filter weights (e.g., from the 3×3 filter kernel 540) are known, for example, as shown FIG. 5A. Aspects of the present disclosure leverage this knowledge by precomputing these multiplication values and storing the results in the lookup table 640. The precomputed multiplication values are stored in the lookup table 640 from a second input (0) of the multiplexer 650. The second input (0) of the multiplexer 650 may also initialize values in the lookup table 640, which may be common to multiple simultaneous MAC operations.

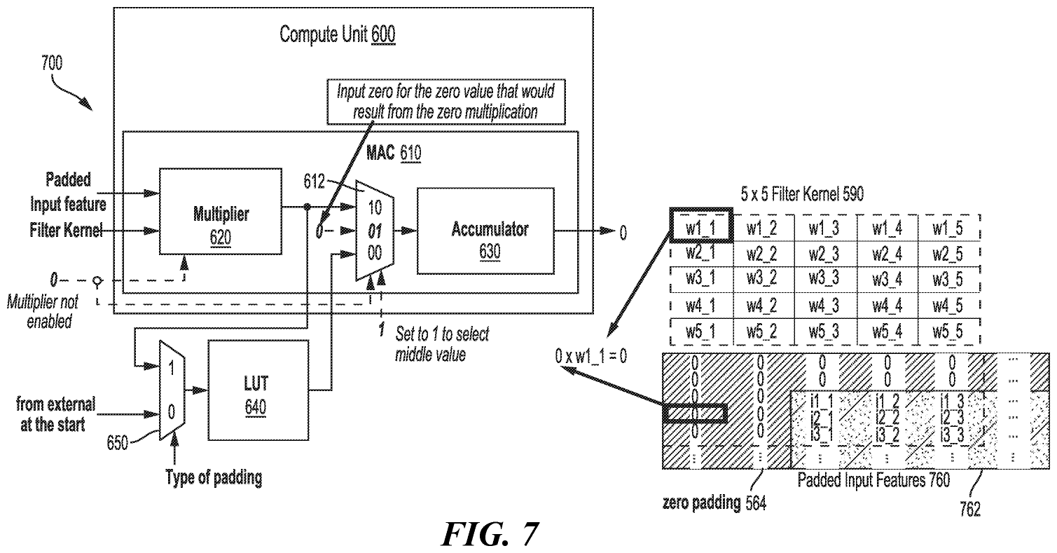

FIG. 7 is a block diagram 700 of an integrated circuit device further illustrating the compute unit 600, including the first MAC cell 610 of FIG. 6, a padded input feature 760 and the 5×5 filter kernel 590 of FIG. 5B, configured to perform fast MAC operations in a zero padding configuration, in accordance with aspects of the present disclosure. In this configuration, zero values in the padded input feature 760 yield a zero result when multiplied by a weight from the 5×5 filter kernel 590 (e.g., 0×w1_1=0). That is, if zero padding is used, then the result of the multiplication is zero, which may be ignored during fast MAC operations. In this aspect of the present disclosure, the multiplier 620 is disabled and the multiplexer 612 provides the zero value to the accumulator 630 during the fast MAC operation.

Although FIGS. 6 and 7 show a compute unit implemented using a single MAC cell (e.g., the first MAC cell 610), it should be recognized that aspects of the present disclosure contemplate the use of alternative configurations. Note that a compute-unit configuration having a single MAC cell, where the individual products of a matrix multiplication are calculated in series, may be useful for a low-power, small-area, or low-cost implementation. A compute-unit configuration having a plurality of MACs, multipliers, selectors, and/or accumulators may be useful for a high-power or high-speed implementation since it may be able to perform a plurality of multiplications in parallel.

In one configuration, an array of MAC cells performs parallel operations according to a single instruction multiple data (SIMD) multiply-accumulate (MAC) operation. In this configuration, the array of MAC cells comprises a plurality of MAC cells including, for example, the first MAC cell 610 as well as a second MAC cell including a second multiplier (e.g., 620) configured to receive a second value of a padded input feature and a second weight of a filter kernel, and a second selector (e.g., multiplexer 612). Depending on the configuration, the second MAC cell may include a second accumulator (e.g., 630) or may share the accumulator of the first MAC cell. In this configuration, the lookup table 640 may be shared by the selectors of the array of MAC cells In another configuration, the compute unit may comprise a multiply, accumulate, and reduce tree, where a binary tree of accumulators is fed by a plurality of selectors to output the scalar dot product of two matrices Each selector selects among a corresponding multiplier output (which multiplies values from the two matrices), a LUT output (which provides the previously determined product of the two values), and/or a zero input. Note that, alternatively, any other suitable configuration of multipliers, selectors, and accumulators may be used by the compute unit.

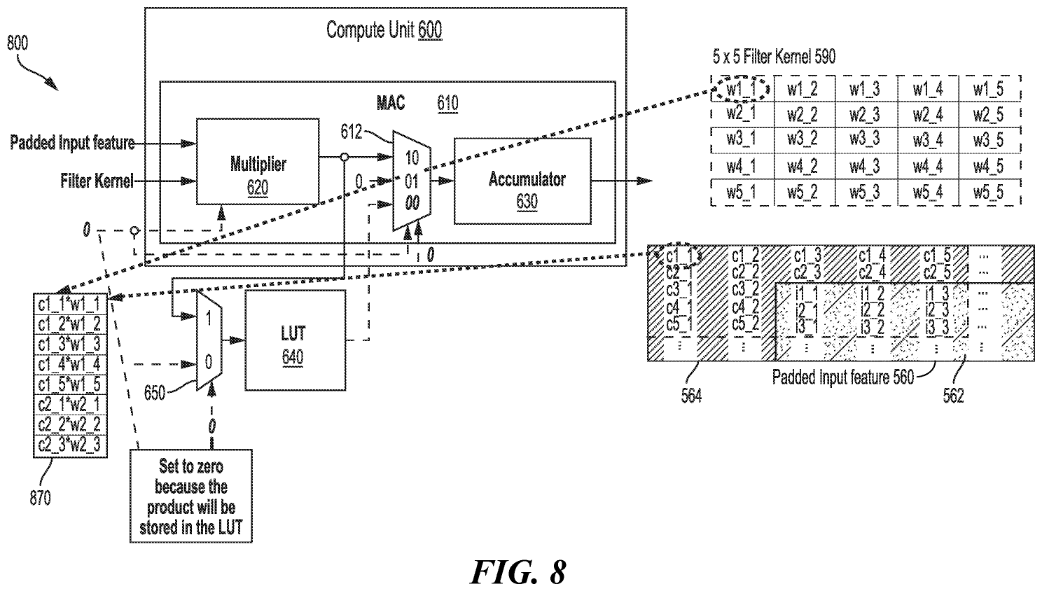

FIG. 8 is a block diagram 800 of an integrated circuit device further illustrating the compute unit 600, including the first MAC cell 610, configured to perform fast MAC operations in a constant padding configuration, in accordance with aspects of the present disclosure. In this example, the first MAC cell 610 has knowledge of the padding values (e.g., constant padding values). That is, the padded input feature 560 includes constant padding values 564 (e.g., c1_1, . . . , c5_2), rather than the zero padding values of the padded input feature 760, as shown in FIG. 7. Therefore, control logic of the first MAC cell 610 is aware that these constant values will be used at a later time. As such, the system precomputes the results of multiplications of weights from the filter kernel 590 and the constant padding values 564 from the padded input feature 560. The precomputed multiplication values 870 (e.g., c1_1*w1_1, . . . , C2_3*W2_3) are stored in the lookup table 640.

In operation, the multiply enable signal (Mul_en) is set to zero to disable the multiplier 620 when a stored precomputed multiplication value is available. In this configuration, a first input of the multiplexer 612 is selected to receive the precomputed multiplication value from the lookup table 640. In addition, the second input of the second multiplexer is selected to store the precomputed multiplication values 860 in the lookup table 640 using, for example, a precomputed address. During this initialization operation, the lookup table 640 is receiving values to store from an external source. During operation, the second input of the multiplexer 650 is selected to store new multiplication values computed by the multiplier 620. For example, the multiplexer 650 (e.g., off-cell selector) is configured to supply, as the input to the lookup table 640, a precomputed multiplication product (e.g., 870) of a padding value of the padded input feature 560 and a weight of the filter kernel 590 from the external source.

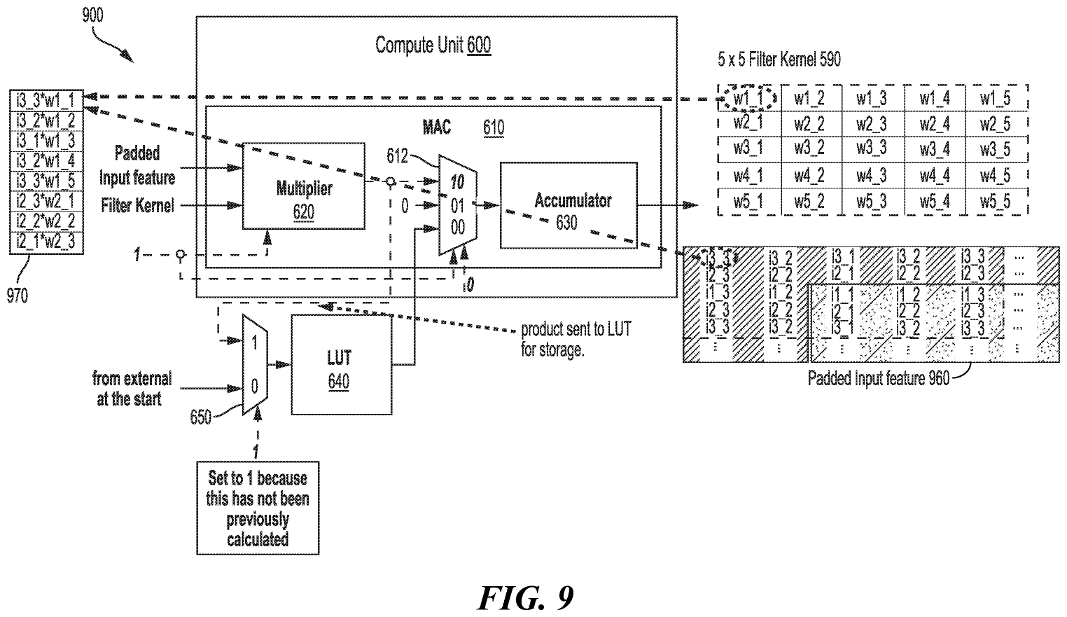

FIG. 9 is a block diagram 900 of an integrated circuit device further illustrating the compute unit 600, including the first MAC cell 610 of FIG. 6 configured to perform fast MAC operations in a mirror padding configuration of a padded input feature 960, according to aspects of the present disclosure. In this example, new multiplication values 970 are generated by the multiplier 620, which is enabled with asserted value (“1”). In addition, a zero value is fed to a control input of the multiplexer 612 to select the output of the multiplier 620 at a third input (“10”) of the multiplexer 612. The new multiplication values 970 are routed and stored in the lookup table 640 through the second input (0) of the multiplexer 650 by feeding the asserted value “1” to a control input of the multiplexer 650.

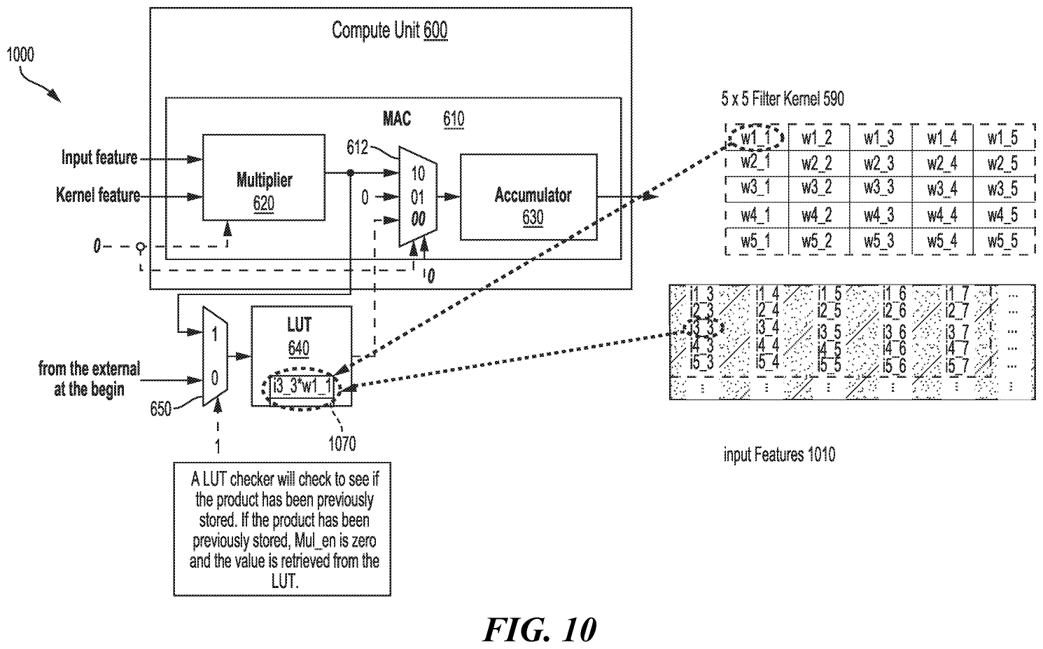

FIG. 10 is a block diagram 1000 of an integrated circuit device further illustrating the compute unit 600, including the first MAC cell 610 of FIG. 6 configured to perform fast MAC operations, according to aspects of the present disclosure. In this example, a lookup table hit occurs from a stored multiplication value 1070 in the lookup table 640 (LUT). In this example, LUT control logic (not shown) checks to see if a multiplication product (e.g., i3_3*w1_1 computed in FIG. 9) was previously computed by the multiplier 620 and stored in the lookup table 640. If a stored multiplication value 1070 corresponds to the product, the multiplier 620 is disabled with a deasserted value (“0”) on the multiply enable (Mul_en) signal. In addition, a zero value is fed to a select line of the multiplexer 612 to select the output of the lookup table 640 at a first input (“00”) of the multiplexer 612. In this example, input features 1010 are shown in a non-padded configuration.

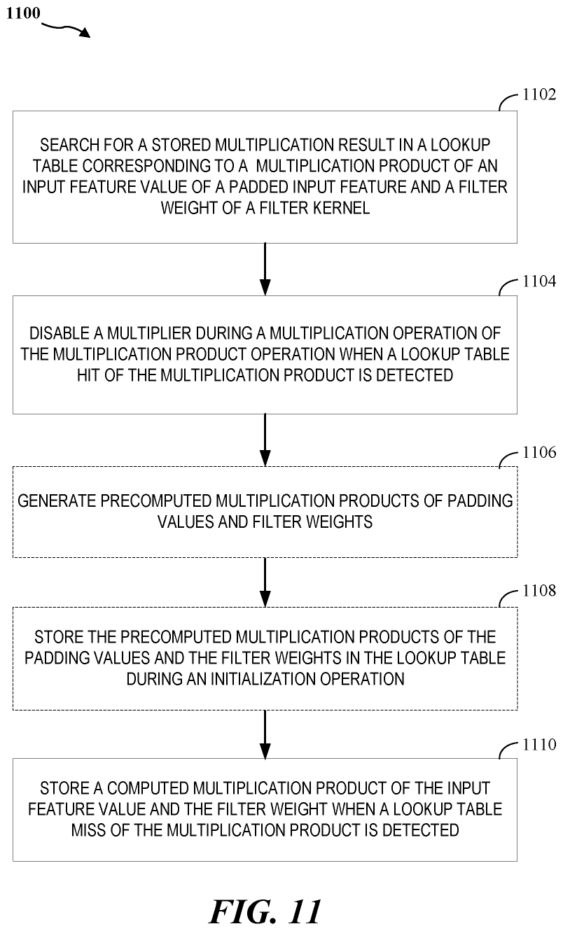

FIG. 11 illustrates a method for performing multiply-accumulate (MAC) operations in a convolutional neural network (CNN) according to a padding type, in accordance with aspects of the present disclosure. A method 1100 begins at block 1102, in which in a lookup table is searched for a stored multiplication result corresponding to a multiplication product of an input feature value of a padded input feature and a filter weight of a filter kernel. For example, as shown in FIG. 10, the lookup table 640 is searched for the stored multiplication result corresponding to a multiplication product (e.g., i3_3*w1_1) previously computed by the multiplier 620 and stored in the lookup table 640.

Referring again to FIG. 11, in block 1104, a multiplier is disabled during a multiplication operation of the multiplication product operation when a lookup table hit of the multiplication product is detected. For example, as shown in FIG. 10, the multiplier 620 is disabled with a deasserted value (“0”) on the multiply enable line (Mul_en) signal in response to the lookup table hit of the stored multiplication value 1070. The method 1100 optionally includes generating precomputed multiplication products of padding values and filter weights at block 1106. Once generated, the method 1100 optionally includes storing the precomputed multiplication products in the LUT during an initialization operation at block 1108 to support fast MAC operations when processing padding values of an input feature.

In block 1110, a computed multiplication product of the input feature and the filter weight is stored in the lookup table when a lookup table miss of the multiplication product is detected. For example, as shown in FIG. 9, new multiplication values 970 are generated by the multiplier 620, which is enabled with an asserted value (“1”). In addition, a zero value is fed to a control input of the multiplexer 612 to select the output of the multiplier 620 at a third input (“10”) of the multiplexer 612. The new multiplication values 970 are routed and stored in the lookup table 640 through the second input of the multiplexer 650 by feeding the asserted value “1” to a control input of the multiplexer 650.

In some aspects, the method 1100 may be performed by the SOC 100 (FIG. 1). That is, each of the elements of method 1100 may, for example, but without limitation, be performed by the SOC 100 or one or more processors (e.g., CPU 102) and/or other components included therein.

Aspects of the present disclosure are directed to improving the multiplication portion of MAC operations in convolutional neural networks by leveraging the padded values. Once pre-processing/padding of the neural network activations is complete, the values written in the padding area are known. Aspects of the present disclosure leverage this knowledge by augmenting the traditional multiply and add schema by using a lookup table and an address generator. In one configuration, items in the lookup table are addressed as a function of a multiplier, an activation value, and a weight value, while new multiplication products are stored in the lookup table to enable subsequent fast MAC operations in a convolutional network.

The model includes means for searching, means for disabling, first means for storing and/or second means for storing. In one aspect, the searching means, disabling means, and/or storing means may be the CPU 102, program memory associated with the CPU 102 and memory block 118 configured to perform the functions recited. The means for storing includes means for enabling, means for generating, and/or means for saving. In one aspect, the enabling means, the generating means, and/or the saving means may be the CPU 102, program memory associated with the CPU 102, memory block 118 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An integrated circuit device, comprising:
a lookup table (LUT) configured to store a plurality of values; and
a compute unit, comprising:
an accumulator,
a first multiplier configured to receive a first value of a padded input feature and a first weight of a filter kernel, and
a first selector configured to select an input to supply to the accumulator between an output from the first multiplier and an output from the LUT.

2. The integrated circuit device of claim 1, in which the plurality of values comprise precomputed products of a plurality of input features.

3. The integrated circuit device of claim 1, further comprising:
an off-cell selector configured to select an input to supply to the LUT between an external source or the first multiplier, in which the off-cell selector further comprises a select line configured to select the input to supply to the LUT based on a padding type of the padded input feature.

4. The integrated circuit device of claim 3, in which the off-cell selector is configured to supply, as the input to the LUT, a product of the first value of the padded input feature and the first weight of the filter kernel from the first multiplier when a new multiplication product is detected.

5. The integrated circuit device of claim 3, in which the off-cell selector is configured to supply, as the input to the LUT, a precomputed multiplication product of a padding value of the padded input feature and the first weight of the filter kernel from the external source.

6. The integrated circuit device of claim 1, further comprising a multiply enable line configured to enable the first multiplier to compute a multiplication product of the first value of the padded input feature and the first weight of the filter kernel when the multiplication product is not stored in the LUT.

7. The integrated circuit device of claim 6, in which the multiply enable line is further configured to disable the first multiplier when the multiplication product is stored in the LUT.

8. The integrated circuit device of claim 1, in which the first selector comprises a zero padding select line configured to select a zero input of the first selector to supply as the input to the first accumulator when a zero padding type is used to pad the padded input feature.

9. The integrated circuit device of claim 1, in which the compute unit further comprises:
a second multiplier configured to receive a second value of the padded input feature and a second weight of the filter kernel; and
a second selector configured to select an input to the accumulator.

10. The integrated circuit device of claim 1, in which the compute unit comprises an array of multiply-accumulate (MAC) cells, in which the LUT is shared by the array of MAC cells.

11. A method for performing multiply-accumulate (MAC) operations in convolutional neural networks, comprising:
searching for a stored multiplication result in a lookup table (LUT) corresponding to a multiplication product of an input feature value of a padded input feature and a filter weight of a filter kernel;
disabling a multiplier during a multiplication operation of the multiplication product when a lookup table hit of the multiplication product is detected; and
storing a computed multiplication product of the input feature value and the filter weight when a lookup table miss of the multiplication product is detected.

12. The method of claim 11, further comprising:
generating a plurality of precomputed multiplication products of padding values of the padded input feature and filter weights of the filter kernel; and
storing the plurality of precomputed multiplication products in the LUT during an initialization operation.

13. The method of claim 11, further comprising disabling the multiplier when processing zero padding values of the padded input feature.

14. The method of claim 11, further comprising disabling the multiplier when processing padding values of the padded input feature.

15. The method of claim 11, in which storing the computed multiplication product further comprises:
enabling the multiplier to generate the computed multiplication product of the input feature value of the padded input feature and the filter weight of the filter kernel;
generating an address corresponding to the computed multiplication production; and
saving the computed multiplication product in the LUT according to the address.

16. An integrated circuit configured to perform multiply-accumulate (MAC) operations in convolutional neural networks, comprising:
means for searching for a stored multiplication result in a lookup table (LUT) corresponding to a multiplication product of an input feature value of a padded input feature and a filter weight of a filter kernel;
means for disabling a multiplier during a multiplication operation of the multiplication product when a lookup table hit of the multiplication product is detected; and
first means for storing a computed multiplication product of the input feature value of the padded input feature and the filter weight of the filter kernel when a lookup table miss of the multiplication product is detected.

17. The integrated circuit of claim 16, further comprising:
means for generating a plurality of precomputed multiplication products of padding values of the padded input feature and filter weights of the filter kernel; and
second means for storing the plurality of precomputed multiplication products in the LUT during an initialization operation.

18. The integrated circuit of claim 16, in which the means for disabling the multiplier operates when processing zero padding values of the padded input feature.

19. The integrated circuit of claim 16, further comprising means for disabling the multiplier when processing padding values of the padded input feature.

20. The integrated circuit of claim 16, in which the first means for storing further comprises:
means for enabling the multiplier to generate the computed multiplication product of the input feature value of the padded input feature and the filter weight of the filter kernel;
means for generating an address corresponding to the computed multiplication production; and
means for saving the computed multiplication product in the LUT according to the address.
